(19) United States
(12) Patent Application Publication
(10) Pub. No.: US 2006/0075669 A1
(43) Pub. Date: Apr. 13, 2006

(54) Display device having a main board and display members attachable to the main board

(76) Inventor: Chao-ken Chuang, Tainan City (TW)

Correspondence Address: PRO-TECHTOR INTERNATIONAL, 20775 Norada Court, Saratoga, CA, 95070-3018, US

(21) Appl. No.: 10/961,651

(22) Filed: Oct. 8, 2004

(51) Int. Cl. G09F 7/00

(52) U.S. Cl. 40/620

(57) ABSTRACT

A display device includes a main board formed of a hard paperboard covered with a layer of soft flannelette, which has a floss evenly distributed over the surface thereof, and a number of display members respectively formed of a nonwoven fabric material attachable to the floss of the layer of soft flannelette and printed with a respective design, for example, word, numeral, logo, pattern, . . . etc.

### BACKGROUND OF THE INVENTION

1. Field of the Invention

The present invention relates to a display device and more particularly, to a display device having a main board and display members attachable to the main board by means of the attraction of static electricity.

2. Description of the Related Art

FIG. 1 shows a display device according to the prior art. According to this design, the display device comprises a main board 100, which is made of ferrous metal, and a plurality of flat display members 200 attachable to the main board 100. Each display member 200 has a front side printed with a design, and a back side embedded with a magnet 201 for connection to the main board 100 by means of magnetic attraction. This design of display device is complicated and expensive. FIG. 2 shows another design of display device according to the prior art. According to this design, the main board 100 is a paperboard; each display member 200 has a tack 202 at the back side for fastening to the main board 100. This design of display device is not durable in use. Repeatedly mounting and dismounting the display members 200 will soon damage the main board 100.

### SUMMARY OF THE INVENTION

The present invention has been accomplished under the circumstances in view.

According to one aspect of the present invention, the display device comprises a main board and at least one display member printed with a respective design. The main board is a hard paperboard covered with a layer of soft flannelette that has floss evenly distributed over the surface thereof. Each display member is formed of a nonwoven fabric material attachable to the floss of the layer of soft flannelette by means of the attraction of static electricity.

According to another aspect of the present invention, the main board has at least one folding line through which the main board can be folded up to reduce space occupation when not in use.

### BRIEF DESCRIPTION OF THE DRAWINGS

FIG. 1 is a sectional view of a display device according to the prior art.

FIG. 2 is a sectional view of another design of display device according to the prior art.

FIG. 3 is an exploded view of a display device according to the present invention.

FIG. 4 is a sectional view of the display device according to the present invention.

FIG. 5 corresponds to FIG. 4 but showing the both sides of the main board respective covered with a layer of soft flannelette.

FIG. 6 corresponds to FIG. 4 but showing the display members attached to the layer of soft flannelette at one side of the main board.

FIG. 7 corresponds to FIG. 5 but showing the display members attached to the flannelette at the front and back sides of the main board.

FIG. 8 shows one application example of the present invention.

FIG. 9 shows another application example of the present invention.

FIG. 10 shows still another application example of the present invention.

FIG. 11 shows still another application example of the present invention.

FIG. 12 is an exploded view of the present invention, showing the main board made in the form of a book.

FIG. 13 is a plain view of the present invention, showing the display members constructed a puzzle.

FIG. 14 is a plain view showing the main board provided with one folding line according to the present invention.

FIG. 15 is a plain view showing the main board provided with two parallel folding lines according to the present invention.

FIG. 16 shows the folded status of the main board of FIG. 14.

FIG. 17 shows the folded status of the main board of FIG. 15.

FIG. 18 is a sectional assembly view of an alternate form of the display device according to the present invention.

FIG. 19 is a sectional assembly view of another alternate form of the display device according to the present invention.

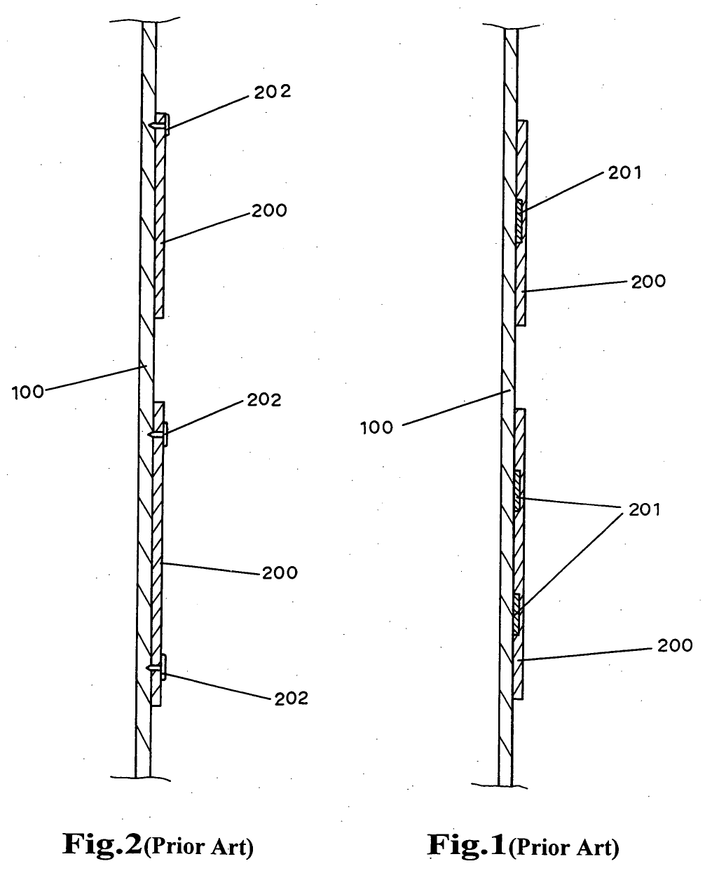

### DETAILED DESCRIPTION OF THE PREFERRED EMBODIMENT

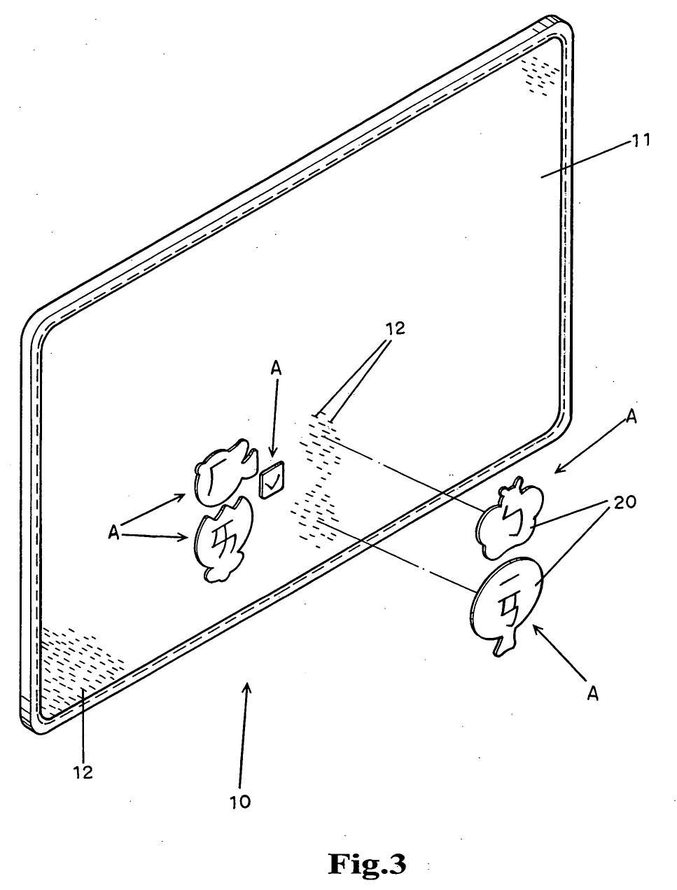

Referring to FIGS. 3˜5, a display device in accordance with the present invention is generally comprised of a main board 10 and a number of display members 20 attachable to the main board 10.

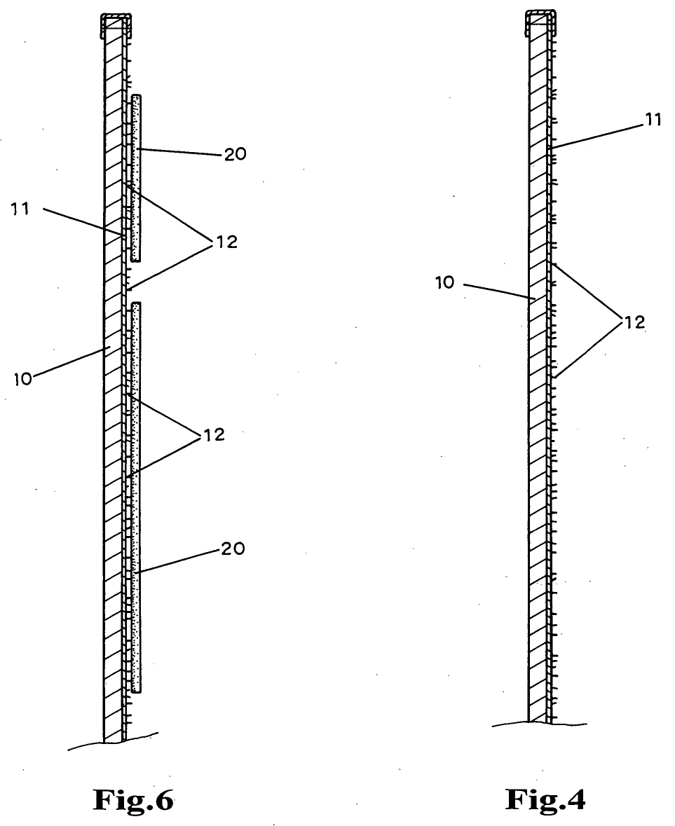

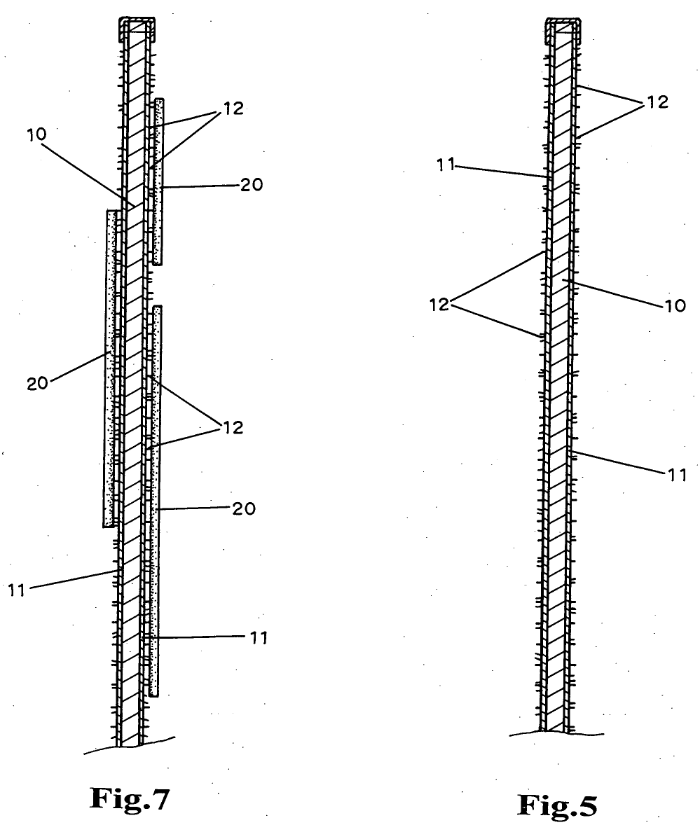

The main board 10 is a hard paperboard having one side, namely, the front side covered with a layer of soft flannelette 11 (see FIG. 4). The flannelette 11 has evenly distributed floss 12 on the surface. Alternatively, the main board 10 can be made having the both sides, namely, the front and back sides respectively covered with a layer of soft flannelette 11 (see FIG. 5).

The display members 20 are small flat nonwoven fabric members, each carrying a respective design A. The display members 20 can be made having any of a variety of shapes. The design A of each display member 20 can be a letter, a word, a numeral, a pattern, a logo, . . . etc.

Referring to FIGS. 6 and 7, when the user attached the display members 20 to the soft flannelette 11 of the main board 10, a static electricity is produced between the floss 12 of the flannelette 11 and the nonwoven fabric of the display members 20 to secure the display members 20 to the flannelette 11 steadily.

Referring to FIG. 7 again, the main board 10 can be hung on a high place to show the display members 20 on the both sides.

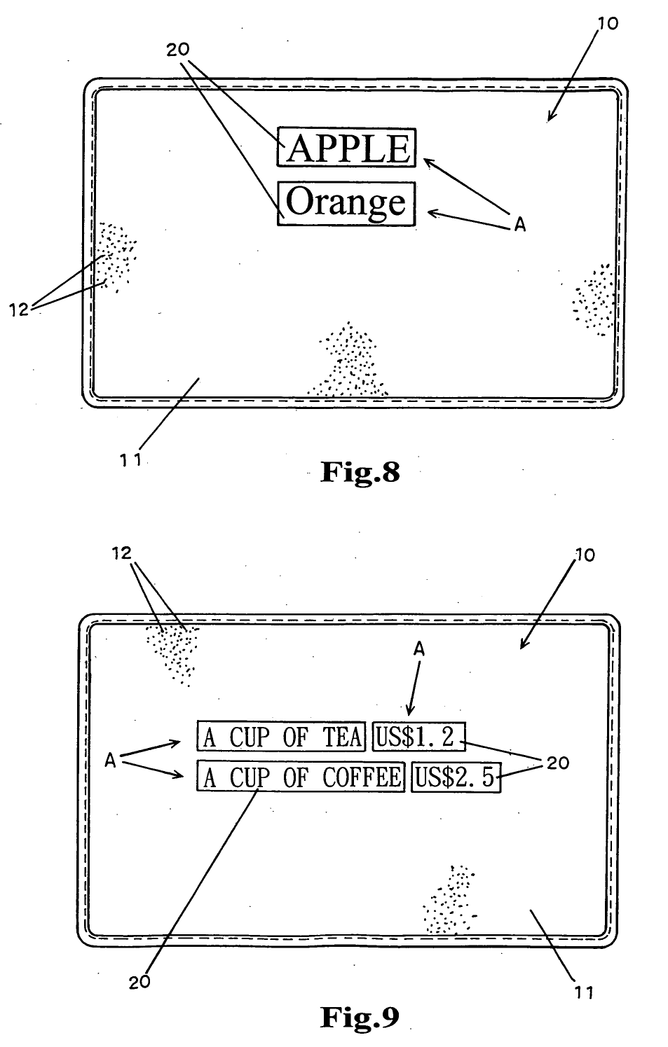

Referring to FIG. 8 and FIG. 3 again, the display members 20 are designed for use with the main board 10 to teach children to learn words.

Referring to FIG. 9, the display members 20 are designed for use with the main board 10 to indicate product price.

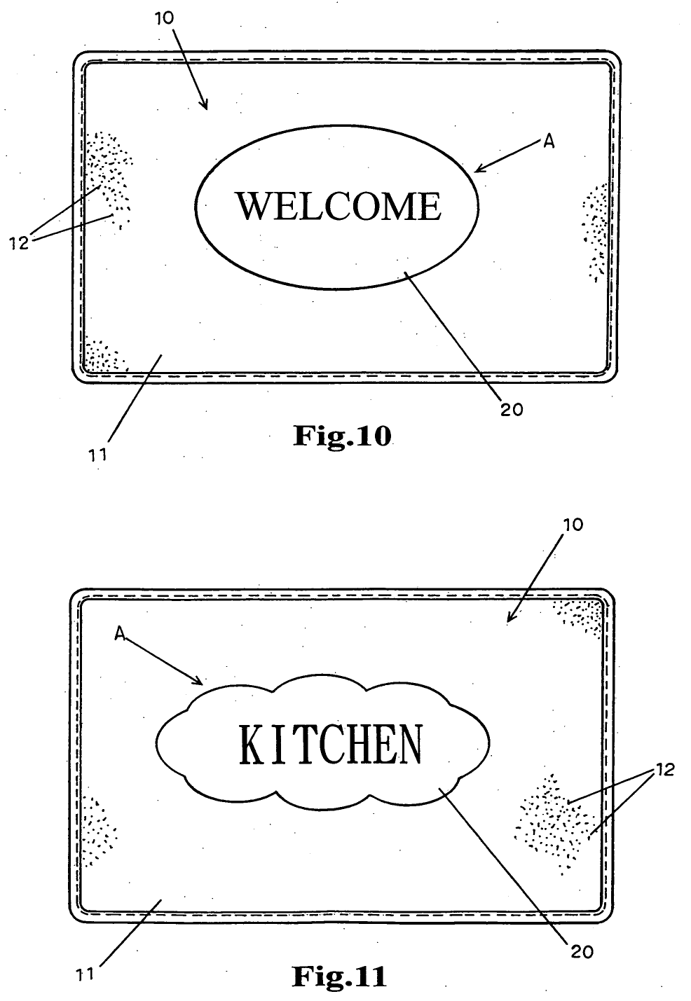

Referring to FIG. 10, the display member 20 is used with the main board 10 as a welcome display board to show a kindly greeting.

Referring to FIG. 11, the display member 20 is used with the main board 10 as an indication board to show a place (room).

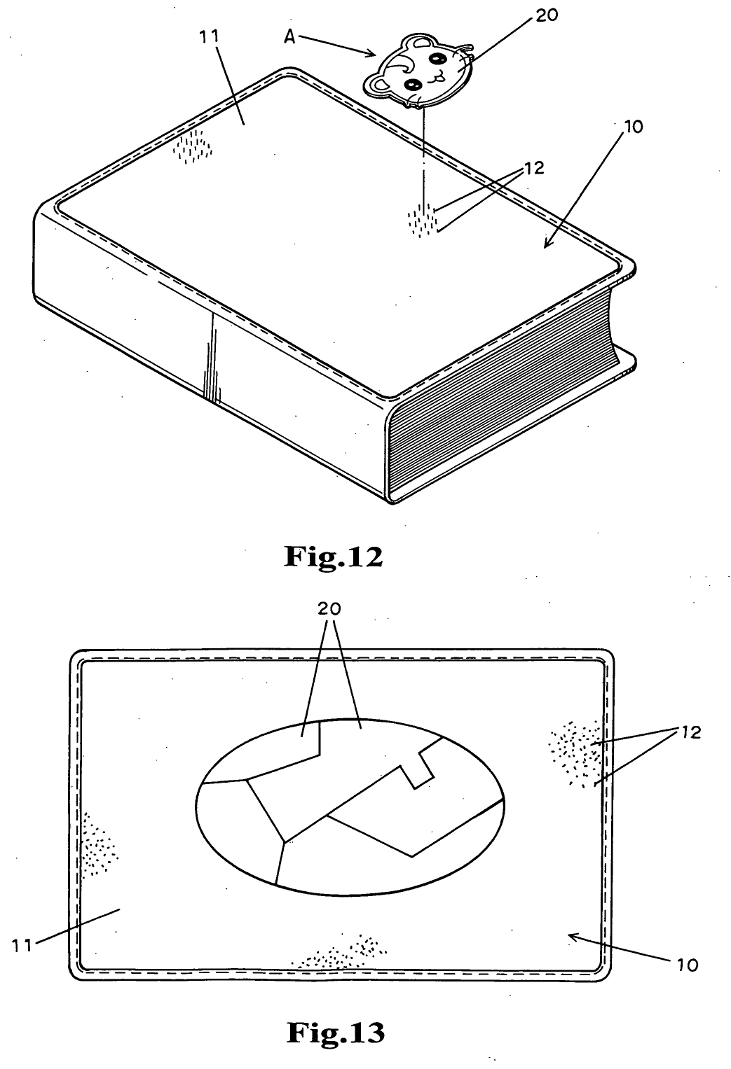

Referring to FIG. 12, the main board 10 is made in the form of a book, and the display member 20 is used an ornament to decorate the book-shaped main board 10.

Referring to FIG. 13, the display members 20 form a puzzle attached to the flannelette 11 of the main board 10.

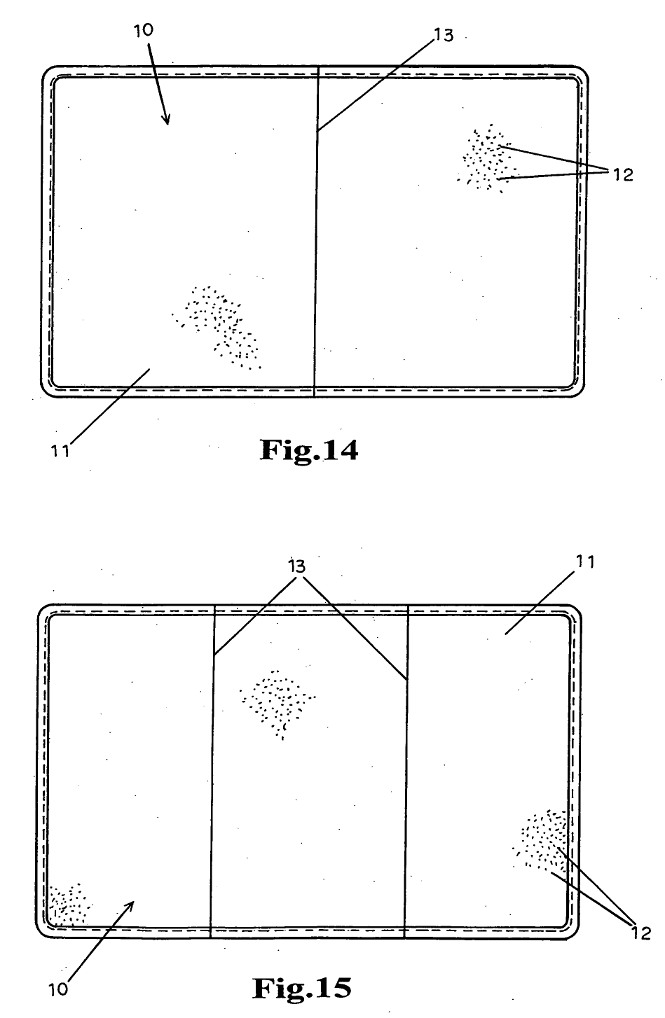

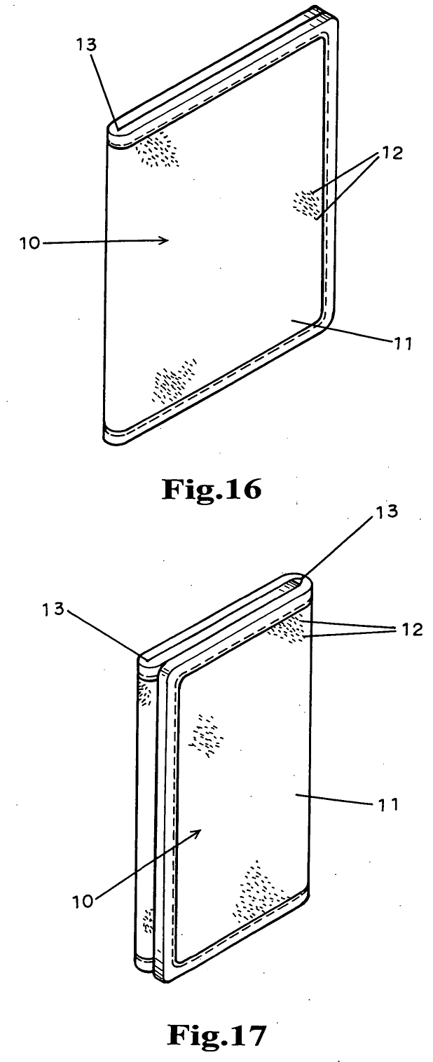

Referring to FIGS. 14˜17, the main board 10 is made having at least one folding line 13 so that the main board 10 can be folded up to reduce space occupation when not in use.

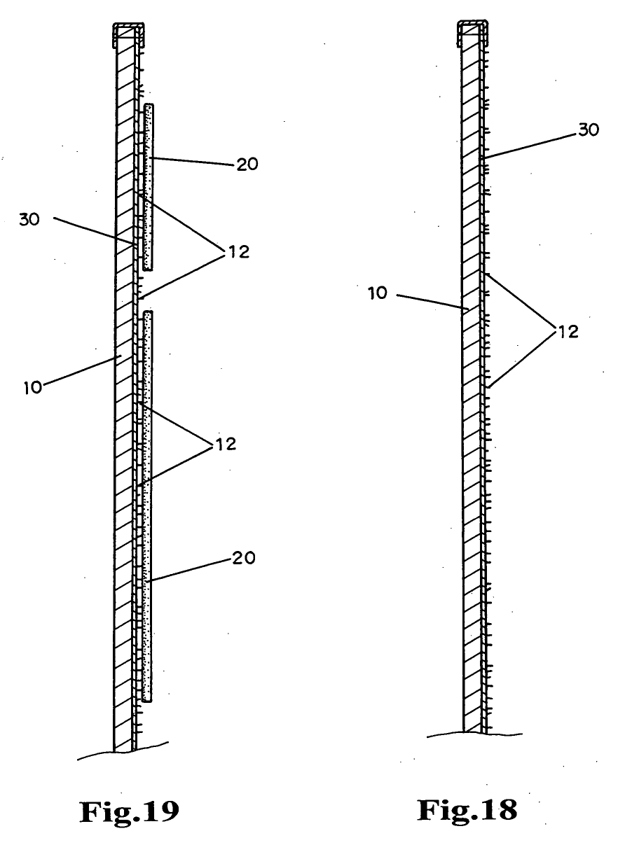

Referring to FIGS. 18 and 19, the main board 10 may be directly covered with a layer of floss 30 for securing display members 20.

As indicated above, the invention has the following advantages:

1. By means of static electricity, the display members 20 are detachably secured to the main board 10. Therefore, the user can rapidly attach the display members 20 to the main board 10 and remove the display members 20 from the main board 10 with less effort.

2. Because the flannelette 11 can be easily be covered on and affixed to the main board 10 for securing the display members 20, the fabrication of the present invention is simple and inexpensive.

3. The display members 20 can be printed with any of a variety of designs for different display purposes.

4. The main board 10 can be made having at least one folding line 13 so that the display device can be folded up to reduce space occupation when not in use.

Although particular embodiments of the invention have been described in detail for purposes of illustration, various modifications and enhancements may be made without departing from the spirit and scope of the invention.

1. A display device comprising.
a main board having at least one side thereof covered with a fabric of soft flannelette;
and at least one display member formed of a nonwoven fabric which is dissimilar to said flannelette;
wherein said at least one display member is attachable to said flannelette covering of said main board by static electricity.

2. The display device as claimed in claim 1, wherein said main board is formed of a hard paperboard, and is oriented in a substantially vertical position.

3. The display device as claimed in claim 1, wherein said main board has at least one folding line through which said main board is foldable.

4. The display device as claimed in claim 1, wherein at least one of said display members carries a design.

5. (canceled)

6. (canceled)
